(19) United States
(12) Patent Application Publication
(10) Pub. No.: US 2025/0320108 A1
(43) Pub. Date: Oct. 16, 2025

(54) SELF-CLOSING FILLING NOZZLE

(71) Applicant: ELAFLEX HIBY GMBH & CO. KG, Hamburg (DE)

(72) Inventors: Ulrich MEYER, Hamburg (DE); Sebastian VIETS, Moisburg (DE)

(21) Appl. No.: 18/026,998

(22) PCT Filed: Sep. 22, 2021
(86) PCT No.: PCT/EP2021/076094

§ 371 Date: Aug. 30, 2023

(30) Foreign Application Priority Data
Sep. 29, 2020 (EP) 20198850.8

(51) Int. Cl. B67D 7/48; B67D 7/52

(52) U.S. Cl. CPC B67D 7/48; B67D 7/52

(57) ABSTRACT

The present invention relates to a nozzle for dispensing a fluid, with an inlet (2) for the connection of a fluid feed line, a main channel (16) which connects the inlet (2) to an outlet (25), with a main valve (5) for controlling a total volumetric flow through the main channel (16), and with a vacuum line (9) which opens into the main channel (16). According to the invention, the main channel (16) merges downstream of the main valve (5) into a part channel (10) and into at least one bypass channel (20a-20e) which runs parallel to the part channel (10), the part channel (10) and/or the at least one bypass channel (20a-20e) having means for prioritizing the fluid throughflow, which means are configured in such a way that a relative proportion of the total volumetric flow which flows through the part channel (10) decreases as the total volumetric flow increases, the part channel (10) having a tapered portion (33), and the vacuum line (9) opening in the region of the tapered portion (33) into the part channel (10). The vacuum generation is considerably improved by virtue of the part channel according to the invention, with the result that the reliability of an automatic switch-off device which is loaded by the vacuum is improved.

The present invention relates to a nozzle for dispensing a fluid. The nozzle comprises an inlet for the connection of a fluid feed line, and a main channel which connects the inlet to an outlet of the nozzle. In addition, the nozzle comprises a main valve for controlling a total volumetric flow through the main channel and a vacuum line which opens into the main channel. A nozzle of this type is known, for example, from document EP 2 386 520 A1. In the case of this known nozzle, a vacuum is generated utilizing the Venturi effect with the aid of the vacuum line which opens into the main channel. The cross section of the main channel is reduced in the region of the main valve, with the result that fluid which flows through the nozzle is accelerated in the region of the main valve, the dynamic pressure increasing and the static pressure decreasing in the region of the cross-sectional tapered portion. The decrease in the static pressure can be utilized to generate a negative pressure via the vacuum line. The vacuum can be used in a known way, for example, to load an automatic switch-off device.

In the case of previously known nozzles, the volumetric flow which is to be output by the nozzle can often be set in a variable manner. For instance, the opening stroke of the main valve can usually be selected manually by way of the position of a hand lever, and the volumetric flow can thus be set. Furthermore, nozzles for dispensing an aqueous urea solution (Adblue) are known which are normally configured to dispense a first maximum volumetric flow, it being possible for a second maximum volumetric flow which is greater than the first maximum volumetric flow to be set by way of interaction with the tank of a motor vehicle (cf. EP 3 369 700 A1).

It is a problem in the case of the above-described nozzles that the vacuum which is generated by way of the volumetric flow is also subject to corresponding fluctuations on account of the variable volumetric flow. An automatic switch-off device which is loaded by the vacuum therefore fundamentally has to be designed to ensure reliable switching off within the vacuum range which is defined by way of the fluctuations. It is complicated to ensure this structurally. In the case of excessively low volumetric flows or excessively great fluctuations in the volumetric flow, in particular, the tolerance requirements of the components to be manufactured and the costs are very high. Proceeding from this prior art, it is the object of the present invention to provide a nozzle which makes improved vacuum generation possible. This object is achieved by way of the features of the independent claims. Advantageous embodiments are specified in the dependent claims.

According to the invention, the main channel merges downstream of the main valve into a part channel and into at least one bypass channel which runs parallel to the part channel, the part channel and/or the at least one bypass channel having means for prioritizing the fluid throughflow, which means are configured in such a way that a relative proportion of the total volumetric flow which flows through the part channel decreases as the total volumetric flow increases. Furthermore, according to the invention, the part channel has a tapered portion, the vacuum line opening in the region of the tapered portion into the part channel.

Some terms which are used within the context of the invention will be explained first of all. If a main channel merges into two channels which run in parallel (part channel and bypass channel), this means in the context of the present description that the main channel splits at the transition, with the result that a fluid can flow either through the part channel or through the bypass channel. The geometric shape or orientation of the channels relative to one another is not restricted by the term “parallel”. Tapering of the part channel can be realized, in particular, by virtue of the fact that a throughflow cross section provided by walls of the part channel decreases in the flow direction. The part channel can preferably configure a Venturi nozzle together with the vacuum line which opens into it.

The main valve is preferably coupled to a switching lever in a fundamentally known way, in order to move the main valve between a closed position and an open position. Moreover, the main valve can be coupled to an automatic switch-off device. It can be provided, in particular, that the automatic switch-off device is configured in a fundamentally known way (see, for example, EP 2 386 520 A1) to move the main valve into a closed position independently of the position of the switching lever.

By way of the part channel according to the invention which has a tapered portion with a vacuum line which is connected to it, the vacuum generation is decoupled from the main valve and from the total volumetric flow which flows through the main channel. In particular, a part of the throughflow cross section of the main channel is delimited by way of the part channel and is separated from the remaining part of the throughflow cross section which is assigned to the at least one bypass channel.

Since the main channel merges into the part channel and the bypass channel, a part of the total volumetric flow can flow through the part channel and another part of the total volumetric flow can flow through the bypass channel. By way of the means according to the invention for prioritizing the fluid throughflow, the division of the total volumetric flow to the two channels which run in parallel is influenced in a manner which is dependent on the total volumetric flow in such a way that the relative proportion which flows through the part channel decreases as the total volumetric flow increases. This means, for example, that a greater relative proportion of the total volumetric flow can flow through the part channel in the case of a small total volumetric flow. It can be provided, for example, that the total volumetric flow flows completely or substantially completely through the part channel in the case of a low total volumetric flow of between 0 and 5 l/min. As a result, a comparatively high “part channel volumetric flow” can already be generated in the part channel in the case of a small total volumetric flow (on account of the smaller throughflow cross section in comparison with the entire main channel), which part channel volumetric flow can in turn be utilized to generate a desired vacuum.

A decrease in the relative proportion of the total volumetric flow which flows through the part channel means that the bypass channel or channels are also utilized in the case of relatively great overall volumetric flows (for example, from 5 l/min) to receive a part of the total volumetric flow. A greater proportion of the total volumetric flow is therefore conducted through the bypass channels in the case of an increasing total volumetric flow, with the result that the “part channel volumetric flow” rises to a less pronounced extent or can even be kept constant in the optimum case. As a result, the vacuum which is generated by means of the tapered portion also changes to a less pronounced extent in the case of an increasing total volumetric flow, or can even be kept constant over great operating ranges. In this case, an automatic switch-off device which is connected to the vacuum line experiences a constant vacuum over great operating ranges, with the result that the switch-off device can ensure automatic switching off over a great throughflow range with a structurally simple embodiment.

The means for prioritizing the fluid throughflow can be configured to deflect and/or control the fluid flow. In particular, the means for prioritizing the fluid throughflow can be configured to direct a greater relative proportion of the total volumetric flow into the part channel in the case of a low total volumetric flow, and to direct a greater relative proportion of the total volumetric flow into the at least one bypass channel in the case of a great total volumetric flow. To this end, for example, the means for prioritizing the fluid throughflow can have a rigid directing section for directing the fluid flow. As an alternative or in addition, it can also be provided that the means for prioritizing the fluid throughflow have movable directing sections which are configured to at least partially close the part channel and/or the at least one bypass channel in the manner of a valve.

In one preferred embodiment, the means for prioritizing the fluid throughflow have an overflow valve which is configured to at least partially close the bypass channel. The overflow valve can further preferably be configured to completely close the bypass channel. By it being possible for the bypass channel to be closed at least partially or completely by way of the overflow valve, the throughflow quantity which flows through the part channel can be controlled. In the case of a low total volumetric flow as a result of complete closure of the overflow valve, in particular, the total volumetric flow can be conducted completely through the part channel. In the case of a high total volumetric flow, a part of the total volumetric flow can be conducted through the bypass channel by way of opening of the overflow valve, with the result that that relative proportion of the total volumetric flow which flows through the part channel is decreased. The overflow valve can also have a controllable variable valve stroke, with the result that the volumetric flow which flows through the bypass channel can be controlled by way of the valve stroke. A homogeneous throughflow through the part channel and therefore a homogeneous vacuum generation can be ensured by way of the closable overflow valve. If there are a plurality of bypass channels which are separated from one another (and run parallel to one another), a plurality of the bypass channels or else all the bypass channels can in each case have an overflow valve.

It is preferably provided that the overflow valve can be opened by way of a fluid pressure which prevails upstream of the overflow valve. This has the advantage that, in the case of small throughflow quantities which are associated with a correspondingly small fluid pressure, the overflow valve first of all remains closed and therefore a greater fluid quantity or the entire fluid quantity first of all flows through the part channel and ensures reliable vacuum generation there. In the case of greater throughflow quantities, the fluid pressure increases upstream of the overflow valve, with the result that the latter is opened by the fluid pressure and receives a part of the fluid flow which flows through the main channel. That proportion of the fluid flow which flows through the part channel and the associated vacuum are automatically homogenized in this way. The overflow valve or valves can have, in particular, a closing body which is preloaded upstream into a closed position. As a result, the opening capability, depending on the fluid pressure, of the overflow valves can be realized in a simple way. Within the context of the invention, active control of the overflow valves is fundamentally also possible, for example by way of an actuating mechanism which actuates the overflow valves in a manner which is dependent on the total volumetric flow.

In one preferred embodiment, the main channel has at least two bypass channels which run parallel to the part channel, each of the two bypass channels preferably in each case comprising an overflow valve for closing the bypass channel. The overflow valves in each case preferably have a closing body which is preloaded upstream into a closed position, and can be opened by way of a fluid pressure which prevails upstream of the overflow valve. By there being two bypass channels, the fluid can flow past the part channel either through the one or through the other bypass channel. The reliability of the vacuum generation can be increased further as a result, since, if one bypass channel fails (for example, as a result of clogging or malfunctions of the associated overflow valve), a further bypass channel is still available which can receive at least part of the fluid flow.

In the case of one embodiment with two bypass channels, a first one of the overflow valves is preferably configured to be moved into the open position if a first fluid pressure is exceeded, a second one of the overflow valves being configured to be moved into the open position if a second fluid pressure which is different than the first fluid pressure is exceeded. For example, a preload of the closing body of the first overflow valve can be different than a preload of the closing body of the second overflow valve. As an alternative or in addition, the closing bodies of the first and second overflow valve can also have front surfaces which point upstream, can be loaded by the fluid pressure, and differ from one another in terms of a different shape and/or different size. For example, the front surface of the first overflow valve can be larger than the front surface of the second overflow valve. The fluid pressure which prevails upstream is converted into a greater force on account of the larger surface, with the result that the overflow valve with the larger front surface opens first of all and the overflow valve with the smaller front surface opens only at a higher fluid pressure. As a result of the above-described configuration of the overflow valves, the proportion of the volumetric flow which is to flow through the part channel can be predefined with high accuracy and reliability, with the result that the vacuum which is generated there is also set with high reliability over a great throughflow range.

In one preferred embodiment, the main valve has a main valve body and a valve stem which is arranged downstream of the main valve body, at least one section of the part channel being arranged next to the valve stem in the radial direction. In the present case, the arrangement of the section of the part channel radially next to the valve stem means that the section is intersected by an imaginary axis which emanates from the valve stem and lies perpendicularly with respect to the axial direction of the valve stem. The vacuum generation can take place in a space-saving way immediately downstream of the main valve as a result of the arrangement of the part channel radially next to the valve stem. The spacing from a possibly present automatic switch-off device can be kept small, as a result of which the size or length of the spaces and lines to be evacuated can also be reduced. The working range of the automatic switch-off device can be improved further as a result. Moreover, on account of the arrangement of the part channel next to the valve stem, it is not required for modifications to be performed on the mechanism connected to the valve stem for actuating the main valve or on the automatic switch-off device which is connected to it.

The part channel and the at least one bypass channel can preferably be distributed uniformly around the valve stem in the circumferential direction. The number of bypass channels can be more than two, preferably more than three and further preferably five. The homogeneous arrangement leads to a homogeneously distributed fluid throughflow and to a minimization of turbulent flows. The valve stem is preferably arranged substantially centrally in relation to a cross section of the main channel, the part channel and/or the bypass channels further preferably being arranged eccentrically in relation to the cross section of the main channel.

In one preferred embodiment, the nozzle comprises an automatic switch-off device for actuating the main valve, the vacuum line being connected to the automatic switch-off device. The construction of an automatic switch-off device of this type is fundamentally known and is therefore not to be explained in greater detail in the present case.

The nozzle can have a first adjustable maximum volumetric flow and a second maximum volumetric flow which is different than the volumetric flow. The first configuration of a nozzle for dispensing different maximum volumetric flows is fundamentally known, for example, from document EP 3 369 700. It has been shown within the context of the invention that the advantages according to the invention come into particular effect in the case of a nozzle of this type, since the throughflow through the part channel can be designed in an optimum manner for the two maximum volumetric flows with the aid of the bypass channel or the bypass channels and, in particular, with the aid of one or more associated overflow valves. An optimum vacuum and therefore a reliable and secure actuation of the automatic switch-off device can therefore be ensured for the two maximum volumetric flows.

In order to set the first or second maximum volumetric flow, EP 3 369 700 A1 has proposed realizing the first and second maximum volumetric flow with the aid of a limit of the maximum open position of the main valve, an interaction between a signal element of the tank and the main valve taking place via an automatic switch-off device of the nozzle. This solution makes reliable and secure adjustability of the first and second maximum volumetric flow possible, but the solution is structurally complex, since an intervention into the automatic switch-off device of the nozzle is necessary.

In one preferred embodiment, the nozzle comprises the following features:
the nozzle has a first maximum volumetric flow and a second maximum volumetric flow, the second maximum volumetric flow being greater than the first one,
the nozzle has an adjustable flow limiter which is configured separately from the main valve and is configured to selectively limit the fluid throughflow to the first or second maximum volumetric flow,
the nozzle has an actuating device which is configured to interact with a signal element which is assigned to the tank of a motor vehicle and to selectively set the flow limiter to the first or the second maximum volumetric flow.

The above-described concept of a nozzle with a first and second maximum volumetric flow exhibits inventive content possibly independently of the characterizing features of claim 1.

In this case, the term “nozzle” can denote an apparatus for controlling the liquid throughflow during a filling operation. The requirements for the design and method of operation of automatic nozzles for use at gasoline pumps are regulated in DIN EN 13012.

In the preferred embodiment, the nozzle has an adjustable flow limiter which is configured to selectively limit the fluid throughflow to the first or the second maximum volumetric flow. This means that in each case at most the respectively set maximum volumetric flow can pass through at the inlet of the nozzle at a predefined constant fluid pressure as a result of the flow limiter. In particular, the user can control the volumetric flow in each case only up to the respectively set first or second maximum volumetric flow by means of a switching lever and the main valve which is coupled to it. The respectively set maximum volumetric flow therefore limits the maximum liquid delivery per unit time. The second maximum volumetric flow is higher than the first maximum volumetric flow. The preferred embodiment is not restricted to a nozzle with exactly two adjustable maximum volumetric flows; it also comprises embodiments in which the flow limiter can be set to three or more adjustable maximum volumetric flows.

In the above-described embodiment, the adjustable flow limiter is configured separately from the main valve. This means that the flow limiter can be set to the first or second maximum volumetric flow independently of the state of the main valve. The flow limiter can be arranged spaced apart from the main valve upstream or downstream of the main valve.

The selective limitation of the fluid throughflow independently of the main valve and its automatic switch-off mechanism is achieved by the adjustable flow limiter according to the invention being configured separately from the main valve. Therefore, no complicated modifications to the automatic switch-off mechanism and/or to the main valve are required, as a result of which the construction of the nozzle can be simplified and the process reliability can be increased. Moreover, the arrangement of a flow limiter separately from the main valve makes considerably simpler repair in the case of malfunctions possible. Moreover, the flow limiter can possibly be configured to be retrofitted to nozzles which already exist.

In one embodiment, the flow limiter is arranged downstream of the main valve. The flow limiter is preferably arranged in an outlet pipe of the nozzle. As a result of the arrangement of the flow limiter in the outlet pipe, the outlet pipe can be exchanged as a self- contained unit, with the result that simple repair can take place in the case of malfunctions. In addition, it is possible for nozzles to be retrofitted by way of a replacement of the outlet pipe with the flow limiter according to the invention.

The first adjustable maximum volumetric flow can be less than 15 l/min; it preferably lies between 5 l/min and 15 l/min and further preferably between 5 l/min and 10 l/min. In addition or as an alternative, the second adjustable maximum volumetric flow can be less than 50 l/min; it preferably lies between 10 l/min and 50 l/min and further preferably between 20 l/min and 40 l/min.

The flow limiter is preferably set as standard to the first adjustable maximum volumetric flow, the second adjustable maximum volumetric flow being set only when the actuating device detects the signal element. Here, the detection of the signal element can take place, in particular, by way of the interaction between the actuating device and the signal element. By the smaller first maximum volumetric flow being set as standard, the delivery of the smaller volumetric flow takes place as standard, greater volumetric flows being dispensed only when it is ensured by way of the detection of the corresponding signal element that the tank to be filled is also suitable on account of its size for the greater second maximum volumetric flow.

In one preferred embodiment, the actuating device is configured for interaction with a ring magnet of a filler neck in accordance with ISO 22241-4. In this case, the signal element can therefore comprise a ring magnet of a filler neck in accordance with ISO 22241-4.

The actuation of the flow limiter for selectively setting the first or second maximum volumetric flow can take place magnetically and/or mechanically (for example, by means of spring elements) and/or pneumatically (for example, by means of compressed air) and/or electrically (for example, by means of an actuating motor). In one preferred embodiment, the actuating device has a displaceably arranged magnet element which is configured for mechanical actuation of the flow limiter. The magnetic force which is generated between the magnet element and the ring magnet can be transmitted mechanically to the flow limiter in order to actuate the latter. In particular, the magnet element can be connected to the flow limiter by way of a mechanical signal transmission apparatus, for example by way of a transmission rod.

The flow limiter can have a throttle valve body, the mechanical signal transmission device or the transmission rod preferably being connected to the throttle valve body. The magnetic force can be transmitted via the transmission rod to the throttle valve body, in order to open or to close the flow limiter. Here, the throttle valve body can preferably be moved in a first direction in the case of an actuation of the flow limiter by way of the signal transmission apparatus. Furthermore, a restoring element which is connected to the throttle valve body is preferably provided, which restoring element can be configured, in particular, to push the throttle valve body in a direction which is opposed to the first direction.

In addition, the flow limiter can have a throttle valve seat, it preferably being possible for the throttle valve body to be moved downstream into a closed position, in which it bears against the throttle valve seat. In this embodiment, the flow limiter can also be called a throttle valve. It is preferably provided that the throttle valve body can be moved into the closed position for selective limiting of the fluid throughflow to the first maximum volumetric flow and can be moved into an open position for selective limiting of the fluid throughflow to the second maximum volumetric flow. The movement into the open position can take place by way of the transmission of the magnetic force by means of the signal transmission apparatus to the throttle valve body. The movement of the throttle valve body into the closed position can take place, for example, by way of the restoring element or can be assisted by way of the latter. As an alternative or in addition, the movement of the throttle valve body into the closed position can also be achieved by virtue of the fact that, when the nozzle is introduced into a filler neck without a ring magnet, the throttle valve body is pressed into the closed position by the fluid pressure.

In particular, the abovementioned setting as standard of the flow limiter to the first maximum volumetric flow can be achieved by way of that movement of the throttle valve body into the closed position which is produced by way of the restoring element or by way of the fluid pressure. If the nozzle is introduced into a filler neck which has a ring magnet, a magnetic force acts between the ring magnet and the magnet element. In the preferred embodiment which is described in the present case, the magnetic force which acts between the ring magnet and the magnet element is configured to move the throttle valve body into the open position counter to a closing force which is produced by the fluid pressure and by the possibly present restoring element, and to also hold it there counter to the closing forces which are produced by the fluid pressure.

A flow guiding device which is configured to reduce the closing force which is exerted on the throttle valve body by the flowing fluid is preferably arranged upstream of the throttle valve body. To this end, in particular, the flow guiding device can have guiding surfaces which are inclined relative to an axial direction of the throttle valve body. Furthermore, the guiding surfaces can be configured to divert the fluid flow from an upstream pointing rear surface of the throttle valve body in the radial direction (that is to say, perpendicularly with respect to the axial direction of the throttle valve body), with the result that at least one part of the fluid flow is preferably conducted past the rear surface. It can be provided, for example, that the guiding surfaces are configured to divert the fluid flow radially to the outside from an axis which runs centrally through the throttle valve body. As a result, a lateral incident flow of the throttle valve body can be ensured, as a result of which the closing forces which are produced by the fluid are decreased.

A movability of the throttle valve body can be limited in the upstream direction by way of a stop. As a result of the limitation of the movability of the throttle valve body, the latter assumes a defined position in the open position.

A bypass channel which bypasses the flow limiter is preferably provided. On account of the bypass channel, the flow limiter does not completely prevent the fluid throughflow through the nozzle, but rather brings about merely a decrease in the fluid throughflow. The bypass channel is preferably configured to allow through the first maximum volumetric flow in the case of a closed flow limiter. The bypass channel can have a through opening, extending through the throttle valve body, for the fluid throughflow. As an alternative or in addition, the bypass channel can also have an auxiliary arm which is spaced apart from the flow limiter and runs parallel to a fluid flow which leads through the open flow limiter.

The nozzle can have a safety valve which is arranged downstream of the flow limiter and is pushed downstream into a closed position by way of a restoring element, it being possible for the safety valve to be moved into an open position by way of interaction with a filler neck of the tank. A safety valve of this type is known, for example, from EP 2 733 113 A1. Moreover, the nozzle preferably has an automatic switch-off device which automatically interrupts the filling operation in the case of a full tank. To this end, a sensor line can be provided which extends as far as the outlet end of the nozzle and is in a pneumatic operative connection to the automatic switch-off device. Details of the configuration of an automatic switch-off apparatus of this type are found, for example, in EP 2 386 520 A1. The safety valve serves firstly as an anti-drip valve, in order to prevent the undesired discharge of residual quantities of the fluid, for example, in the case of a closed main valve.

It can be provided, in particular, that the actuating device is configured such that it can be displaced relative to a valve stem of the safety valve, the valve stem of the safety valve preferably having a cavity, in which the magnet element of the actuating device is arranged displaceably. It has been shown that the arrangement of the magnet element within the valve stem of the safety valve makes a particularly space-saving construction possible. If the actuating device has a transmission rod, the latter can be guided through a through opening in a rear wall of the valve stem.

The subject matter of the present invention is, furthermore, a method for dispensing a fluid with the aid of a nozzle according to the invention, in the case of which method a first proportion of the fluid flow is conducted through the part channel and a second proportion of the fluid flow is conducted through the at least one bypass channel, that proportion of the fluid flow which is conducted through the part channel being used to generate a vacuum.

The at least one bypass channel preferably has an overflow valve, the overflow valve being used to set that proportion of the fluid flow which flows through the part channel. The method according to the invention can be developed by way of further features which have already been described above in conjunction with the nozzle according to the invention.

In the following text, one advantageous embodiment of the invention will be explained by way of example with reference to the appended drawings, in which:

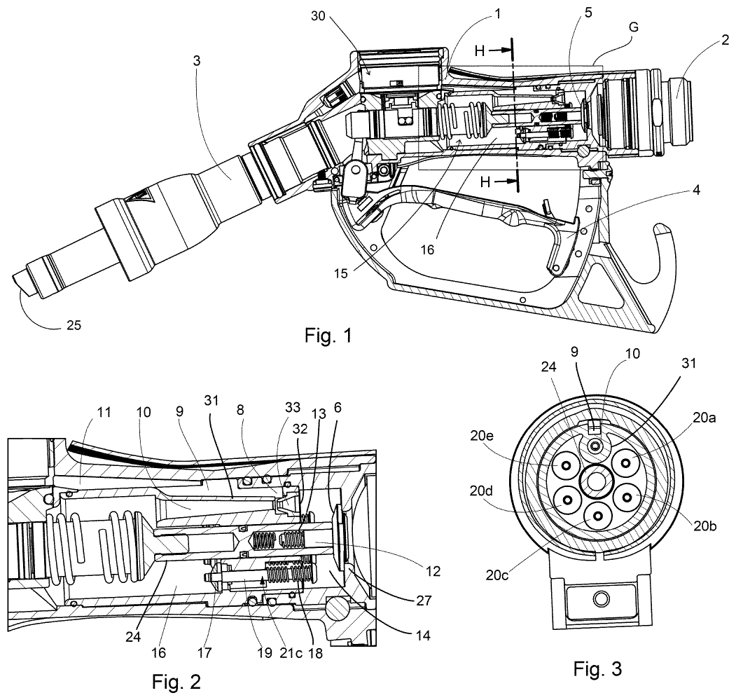

FIG. 1 shows a nozzle according to the invention in a lateral sectional illustration,

FIG. 2 shows a detail from FIG. 1 in an enlarged view,

FIG. 3 shows a cross-sectional view along the line H-H shown in FIG. 1,

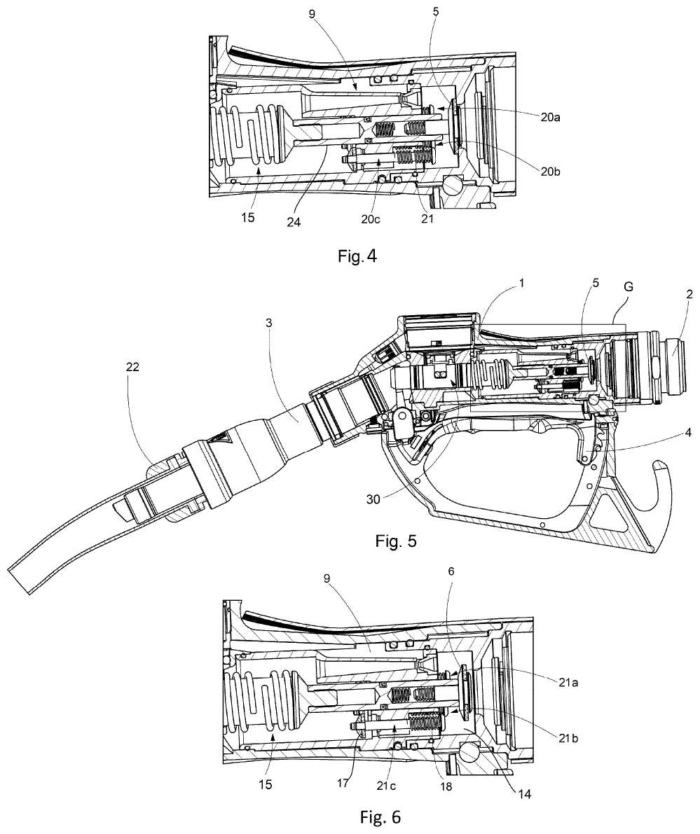

FIG. 4 shows the detail which is shown in FIG. 2 after the actuation of the main valve without a fluid flow,

FIG. 5 shows the nozzle according to the invention from FIGS. 1 to 4 during the delivery of a fluid with a first maximum volumetric flow,

FIG. 6 shows a detail from FIG. 5 in an enlarged view,

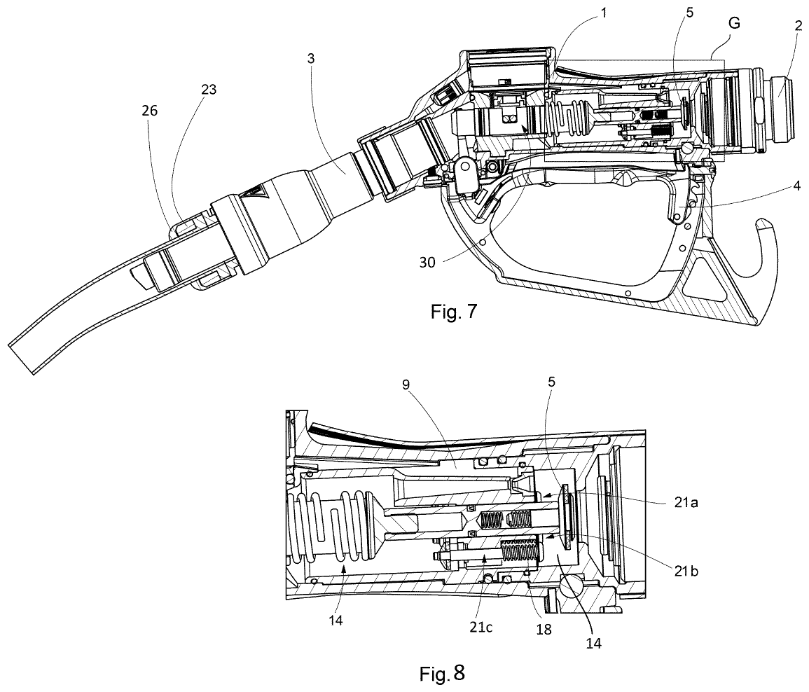

FIG. 7 shows the nozzle according to the invention from FIGS. 1 to 6 during the delivery of a fluid with a second maximum volumetric flow,

FIG. 8 shows a detail from FIG. 7 in an enlarged view,

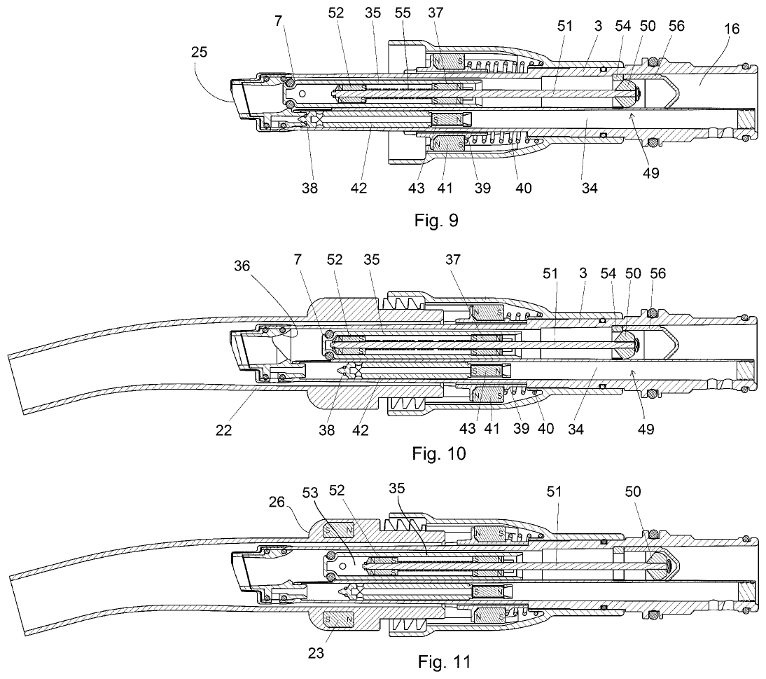

FIG. 9 shows a lateral sectional view through an outlet pipe of the nozzle according to the invention before the actuation of the main valve,

FIG. 10 shows a lateral sectional view through the outlet pipe of the nozzle according to the invention during the delivery of a fluid with the first maximum volumetric flow, and

FIG. 11 shows a lateral sectional view through the outlet pipe of the nozzle according to the invention during the delivery of a fluid with the second maximum volumetric flow.

The nozzle comprises a housing 1 with an inlet 2, to which a feed line for feeding in a fluid can be connected (not shown). An outlet pipe 3 is used at the front end of the housing 1, at the front end of which outlet pipe 3 an outlet 25 is situated. The outlet 25 can be introduced, for example, into a filler neck 22, 26 of a vehicle (see FIGS. 5 and 7).

A main channel 16 extends from the inlet 2 to the outlet 25, in which main channel 16 a main valve 5 for controlling the total volumetric flow is arranged. The main valve 5 comprises a main valve body 6 (see FIG. 2) which can be moved against a main valve seat 27 in order to close the main valve 5. To this end, the valve body 6 is coupled via a valve stem 15 in a fundamentally known way to a switching lever 4 and to an automatic switch-off device 30. The valve stem 15 has an outer sleeve 24 which presses the valve body 6 with a great closing force against the valve seat 27 in the closed position (see FIGS. 1 and 2). Moreover, the valve stem 15 comprises an inner piston 12 which is configured such that it can be moved relative to the outer sleeve 24 and is pushed upstream by way of a restoring element 13 (see FIG. 2). The valve body 6 is connected to the inner piston 12. Upon actuation of the switching lever 4 by way of a user, the outer sleeve 24 of the valve stem 15 is moved downstream and, as a result, is lifted up from the valve body 6. The valve body 6 is then pressed into the closed position merely by way of the restoring force of the restoring element 13 (see also FIG. 4). The restoring force of the restoring element 13 is so small that the valve body 6 can be moved together with the inner piston 12 into the open position by a customary fluid pressure.

The automatic switch-off device 30 is configured to move the main valve 5 into a closed position independently of the position of the switching lever 4. The method of operation of the automatic switch-off device is fundamentally known (see, for example, EP 2 386 520 A1) and is not to be explained in greater detail here.

A sensor line (not shown in FIGS. 1 to 8) extends from the automatic switch-off device 30 through the outlet pipe 3 as far as the outlet 25. The sensor line is in a pneumatic operative connection with the switch-off device 30. When, during the delivery of the fluid, the fluid level reaches the front end of the outlet pipe 3 and covers the sensor line, a pressure change which accompanies this leads to triggering of the automatic switch-off device 30 and, as a consequence, to closing of the main valve 5 independently of the position of the switching lever 4.

The nozzle is configured to selectively output a first maximum volumetric flow or a second maximum volumetric flow. To this end, the nozzle comprises a throttle valve which is arranged in the outlet pipe and is configured to selectively limit the fluid throughflow to the first or second maximum volumetric flow. The throttle valve is actuated by way of interaction with a ring magnet of a filler neck in accordance with ISO 22241-4. As standard, that is to say when there is no ring magnet, the nozzle is set for the delivery of the first maximum volumetric flow. If the outlet pipe 3 is therefore introduced into a filler neck without a ring magnet, at most the first maximum volumetric flow can be dispensed by way of actuation of the switching lever 4. In the present case, the first maximum volumetric flow is 9 l/min. If the outlet pipe 3 is introduced into a filler neck in accordance with ISO 22241-4 with a ring magnet, the second maximum volumetric flow which is 20 l/min in the present case can be dispensed by way of the nozzle. The method of operation of the throttle valve will be explained in even greater detail in conjunction with FIGS. 9 to 11.

The method of operation of the automatic switch-off device 30 requires that it is loaded with a vacuum. The vacuum is generated as described in the following text. The main channel 16 merges downstream of the main valve 5 in the region 14 into a part channel 10 and into five bypass channels 20a to 20e which run parallel to the former (see FIG. 3). The part channel 10 is delimited by walls 31. The part channel 10 has an opening 32 which is defined by the walls 31, and a section 33 which tapers conically in the flow direction starting from the opening 32 (see FIG. 2). An orifice 8 of a vacuum line 9 into the part channel 10 is situated in the region of the section 33. The flow speed of the fluid in the part channel 10 increases on account of the tapering section 33, with the result that the static pressure drops. As a result, a vacuum can be generated via the vacuum line 9 and the automatic switch-off device 30 can be loaded with it. The part channel 10 widens again downstream of the orifice 8 of the vacuum line 9. In this regard, the part channel 10 forms a Venturi nozzle together with the vacuum line.

The bypass channels 20a to 20e in each case have a means for prioritizing the fluid throughflow, which means is configured in the present case in each case as an overflow valve 21a to 21e, it not being possible for the overflow valves 21d and 21e to be seen in the sectional illustration which is shown. In the following text, the overflow valve 21c which is shown in FIG. 2 will be described. It comprises a stem 19 and a closing body 17 which is loaded upstream into a closed position by way of a restoring element 18. In FIGS. 1 to 3, the main valve 5 is closed, with the result that no fluid flows through the main channel 16. The closing body 17 of the overflow valve 21c is correspondingly held in the closed position by way of the restoring element 18. The remaining overflow valves are also situated correspondingly in the closed position thereof in FIGS. 1 to 3.

In the present case, the restoring elements 18 of the overflow valves 21a to 21e have restoring forces which are different than one another, with the result that fluid pressures of different magnitude are required to open the overflow valves 21a to 21e. This will be explained in even greater detail in the following text in conjunction with FIGS. 5 to 8.

By way of actuation of the switching lever 4, the valve stem 15 is displaced downstream, with the result that the outer sleeve 24 of the valve stem 15 is released from the valve body 6 (see FIG. 4). If no fluid is fed in at the inlet 2, the valve body 6 initially remains, as has already been explained above, in the closed position, in which it is pressed against the valve seat 27 by the restoring element 13. This is illustrated in FIG. 4.

Only when a fluid with a certain fluid pressure is fed in at the inlet 2 does the valve body 6 yield to the opening pressure and move into an open position counter to the force of the restoring element 13. This is shown in FIGS. 5 and 6. The fluid can then enter from the inlet 2 first of all into the region 14 upstream of the part channel 10 and the bypass channels 20a-20e. Here, part of the fluid flows into the part channel 10 and another part of the fluid flows in the direction of the overflow valves 21a to 21e. Since the overflow valves 21a to 21e are first of all pushed into the closed position by way of the restoring elements 18, a greater proportion of the fluid initially flows through the part channel 10, with the result that a throughflow is already produced there shortly after the opening of the main valve 5 and a vacuum is generated. After a short time, a fluid pressure is built up on the upstream pointing front surfaces of the closing bodies 17 of the overflow valves 21a to 21e, which fluid pressure is dependent on the feed pressure of the fluid, the open position of the main valve and the flow cross sections available for the fluid flow within the nozzle downstream of the overflow valves 21a to 21e.

FIGS. 5 and 6 show the nozzle according to the invention after the outlet pipe has been introduced into a filler neck 22 of a vehicle and the main valve has been opened. The filler neck 22 is configured in accordance with ISO 22241-5 and does not have a ring magnet. Accordingly, the throttle valve which is situated in the outlet pipe 3 is in the closed position and in the process makes a maximum throughflow through the outlet pipe 3 of approximately 9 l/min possible.

In this state, a fluid pressure prevails in the region 14 upstream of the overflow valves 21a to 21e, which fluid pressure is sufficient to move the closing body of the overflow valve 21c into the open position counter to the force of the restoring element 18 (see FIG. 6). The restoring elements 18 of the overflow valves 21a, 21b and 21c which are shown in this illustration have restoring forces of different magnitude in the present case. In particular, the restoring force of the valve 21c is smaller than that of the valve 21b, and the restoring force of the valve 21b is in turn smaller than the restoring force of the valve 21a. This leads, in the state which prevails in FIGS. 5 and 6, to the overflow valve 21a remaining closed and the overflow valve 21b assuming an intermediate position, in which a slight throughflow is possible, the valve 21c being completely open (see FIG. 6). Here, the restoring forces of the overflow valves are set, in particular, in such a way that the resulting fluid throughflow through the part channel 10 assumes a value which is optimum for the generation of vacuum. The overflow valves 21d and 21e which cannot be seen in this view likewise have a greater restoring force than the overflow valve 21b, and therefore remain closed.

FIGS. 7 and 8 show the nozzle according to the invention after it has been introduced into a filler neck 26 in accordance with ISO 22241-4 with a ring magnet 23. In a way which will be explained in more detail in the following text, the ring magnet 23 actuates the throttle valve, with the result that the nozzle can then dispense a maximum volumetric flow of 20 l/min. On account of the increased maximum volumetric flow, a higher fluid pressure prevails in the region 14 upstream of the part channel 10 and the bypass channels 20a-20e, with the result that all the bypass valves 21a-21e open (see FIG. 8). As a result of all the overflow valves opening, the volumetric flow which flows through the part channel 10 can be kept approximately identical in comparison with the state which is shown in FIGS. 5 and 6. The vacuum which is generated by way of the part channel 10 is therefore substantially constant, independently of whether the first maximum volumetric flow of approximately 9 l/min or the second maximum volumetric flow of approximately 20 l/min is delivered by way of the nozzle. Even in the case of different volumetric flows which can be set, in particular, with the aid of the hand lever and an open position, corresponding to the hand lever position, of the main valve, the overflow valves according to the invention lead to a homogenization of the generated vacuum.

FIG. 9 shows a lateral sectional view through the outlet pipe 3 of the nozzle according to the invention. The sensor line 34 which is in a pneumatic operative connection with the automatic switch-off device 30 can be seen in this view. When, during the delivery of the fluid, the fluid level reaches the front end of the outlet pipe and thus covers the sensor line 34, a pressure change which accompanies this leads to triggering of the automatic switch-off device 30 and therefore to closing of the main valve 5.

Furthermore, a safety valve 7 which has a valve stem 35 and closes downstream against a valve seat 36 (see FIG. 10) is provided in the region of the outlet end of the outlet pipe 3. The upstream pointing end of the valve stem 35 is provided with a magnet 37.

Moreover, the outlet pipe 3 has a sleeve 39 which can be displaced along its axial direction and is preloaded by way of a spring 40 into the shut-off position which is shown in FIG. 9. An annular active magnet 41 is arranged on the sleeve 39, which active magnet 41 pushes the valve stem 35 and the safety valve into the closed position which is shown in FIG. 9 by way of magnetic interaction with the magnet 37.

The sensor line 34 has a sensor line valve 38 which is arranged on the outlet-side end and has a valve stem 42 which closes against a valve seat with its outlet-side end. At the opposite end, the valve stem 42 comprises an actuating magnet 43 which holds the valve stem 42 in the closed position by way of interaction with the active magnet 41.

In the state which is shown in FIG. 9, the main channel 16 is closed by way of the safety valve 7. Moreover, the sensor line 34 is closed by way of the sensor line valve 38. If the main valve 5 is actuated by means of the switching lever 4 in this state, delivery of the fluid is prevented because the outlet pipe is closed by way of the safety valve 7.

Furthermore, an adjustable flow limiter which is configured in the present case by way of a throttle valve 49 is situated in the outlet pipe 3. With the aid of the throttle valve 49, a fluid throughflow through the nozzle or through the outlet pipe 3 can be limited selectively to the first maximum volumetric flow or the second maximum volumetric flow. The throttle valve 49 has a valve body 50 which is connected by means of a transmission rod 51 to a magnet element 52. The magnet element 52 is arranged in a cavity 53 within the valve stem 35 of the safety valve 7, and can be displaced relative to the valve stem 35 in the axial direction of the outlet pipe 3. The transmission rod 51 can likewise be displaced relative to the valve stem 35 and is guided through a through opening which is situated in an upstream pointing rear wall of the valve stem 35.

The magnet element 52 and the transmission rod 51 together form an actuating device for the throttle valve 49. In the state which is shown in FIG. 9, the valve body 50 is situated in a closed position, in which it bears downstream against a valve seat 54 of the throttle valve 49. The valve body 50 is pushed downstream relative to the valve stem 35 by way of a restoring element 55 and, as a result, is stressed into the valve seat 54. The method of operation of the actuating device 51, 52 and the setting of the throttle valve 49 to the second maximum volumetric flow will be explained in conjunction with FIGS. 10 and 11.

FIG. 10 shows the outlet pipe 3 after the introduction thereof into a filler neck 22 of a vehicle tank. In contrast to FIG. 9, moreover, the main valve 5 has been moved into an open position by way of actuation of the switching lever 4. In the present case, the filler neck 22 is the filler neck of a urea tank of a passenger car in accordance with ISO 22241-5 without a ring magnet.

The filler neck 22 is configured in a fundamentally known way (see EP 3 369 700 A1) to displace the sleeve 39 during the introduction of the outlet pipe 3 relative to the latter upstream from the shut-off position (shown in FIG. 9) into an open position. During the displacement of the sleeve 39, the active magnet 41 which is connected to it likewise moves upstream relative to the outlet pipe 3, this active magnet 41 driving, by way of magnetic interaction, the magnet 37 which is fixed on the valve stem 35 and the actuating magnet 43 which is fixed on the valve stem 42, and thus opening the sensor line valve 38 and the safety valve 7.

The magnet element 52 is far enough away from the active magnet 41 that it is not influenced or is influenced only to a negligible extent by the displacement of the active magnet 41. Since the magnet element 52, the transmission rod 51 and the valve body 50 which is connected to it can be moved relative to the valve stem 35 and are pushed into the closed position by the restoring element 55, the valve body 50 remains in the closed position. Through holes which cannot be seen in the sectional view of FIGS. 9 to 11 and through which a certain volumetric flow can pass through the outlet pipe 3 even in the closed position of the valve body 50 are situated in the valve seat 54. This certain volumetric flow is at most as great as the first maximum volumetric flow of the throttle valve which is 9 l/min in the present case. The volumetric flow which passes through the opening of the main valve 5 is therefore limited to the first maximum volumetric flow of the nozzle by way of the closed throttle valve 49. In addition or as an alternative to the through holes which are situated in the valve seat 54, through holes can also be provided in the valve body 50 in one alternative embodiment.

FIG. 11 shows the outlet pipe after the introduction thereof into a filler neck 26 which, in contrast to the filler neck 22 of FIG. 10, is the filler neck of a urea tank of a passenger car in accordance with ISO 22241-4 with a ring magnet 23. Just like in FIG. 10, the main valve 5 is situated in an open position.

During the introduction of the outlet pipe, the sleeve 39 is displaced relative to the outlet pipe 3 by way of the filler neck 26, as has already been described in conjunction with FIG. 10, with the result that both the sensor line valve 38 and the safety valve 7 are opened by way of the interaction between the active magnet 41 and the magnets 37 and 43.

Moreover, an interaction occurs in the present case between the ring magnet 23 and the magnet element 52. In particular, the ring magnet 23 and the magnet element 52 are arranged in such a way that, during the introduction of the outlet pipe 3 into the filler neck 26, first of all identical poles lie opposite one another and a repelling force is thus exerted on the magnet element 52. The magnet element 52 is configured here in such a way that the magnetic force exceeds the counteracting restoring force of the restoring element 55. The repelling force therefore leads to a displacement of the magnet element 52 in the upstream direction relative to the outlet pipe 3. On account of the connection, formed by way of the transmission rod 51, of the magnet element 52 to the valve body 50, the valve body 50 is moved into an open position counter to the restoring force of the restoring element 55. The movement of the valve body 50 is limited upstream by way of a stop 56.

In the open position of the throttle valve 49, a greater volumetric flow can pass through the outlet pipe in the case of a predefined fluid pressure at the inlet of the nozzle than in the closed position which is shown in FIG. 10. In particular, in the state which is shown, the throttle valve 49 is configured, in the case of sufficient opening of the main valve 5, to allow the second maximum volumetric flow to pass through the outlet pipe 3, which second maximum volumetric flow is 20 l/min 5 in the present case. The magnetic force which acts between the ring magnet 23 and the magnet element 52 is so great that the valve body 50 is held in the open position counter to the fluid pressure and counter to the restoring force of the restoring element 55.

1. A nozzle for dispensing a fluid, with an inlet (2) for the connection of a fluid feed line, a main channel (16) which connects the inlet (2) to an outlet (25), with a main valve (5) for controlling a total volumetric flow through the main channel (16), and with a vacuum line (9) which opens into the main channel (16), wherein the main channel (16) merges downstream of the main valve (5) into a part channel (10) and into at least two bypass channels (20a-20e) which run parallel to the part channel (10), the part channel (10) and/or the at least two bypass channels (20a-20e) having means for prioritizing the fluid throughflow, which means are configured in such a way that a relative proportion of the total volumetric flow which flows through the part channel (10) decreases as the total volumetric flow increases, the part channel (10) having a tapered portion (33), and the vacuum line (9) opening in the region of the tapered portion (33) into the part channel (10).

2. The nozzle as claimed in claim 1, in the case of which the means for prioritizing the fluid throughflow are configured to deflect and/or control the fluid flow.

3. The nozzle as claimed in claim 1, in the case of which the means for prioritizing the fluid throughflow have an overflow valve (21a, 21b, 21c, 21d, 21e) which is configured to at least partially close the bypass channel (20a-20e).

4. The nozzle as claimed in claim 3, in the case of which the overflow valve (21a, 21b, 21c, 21d, 21e) can be opened by way of a fluid pressure which prevails upstream of the overflow valve (21a, 21b, 21c, 21d, 21e), the overflow valve (21a, 21b, 21c, 21d, 21e).

5. The nozzle as claimed in claim 4, in the case of which the two bypass channels (20a-20e) which run parallel to the part channel (10) in each case have an overflow valve (21a, 21b, 21c, 21d, 21e) for at least partially closing the bypass channel (20a-20e), the overflow valves (21a, 21b, 21c, 21d, 21e) in each case having a closing body (17) which is preloaded upstream into a closed position, and it being possible for these overflow valves (21a, 21b, 21c, 21d, 21e) to be opened by way of a fluid pressure which prevails upstream of the overflow valves (21a, 21b, 21c, 21d, 21e).

6. The nozzle as claimed in claim 5, in the case of which a first one of the overflow valves (21a, 21b, 21c, 21d, 21e) is configured to be moved into the open position if a first fluid pressure is exceeded, a second one of the overflow valves (21a, 21b, 21c, 21d, 21e) being configured to be moved into the open position if a second fluid pressure which is different than the first fluid pressure is exceeded.

7. The nozzle as claimed in claim 6, in the case of which a preload of the closing body (17) of the first overflow valve (21a) is different than a preload of the closing body (17) of the second overflow valve (21b).

8. The nozzle as claimed in claim 1, in the case of which the main valve (5) has a valve body (6) and a valve stem (15) which is arranged downstream of the valve body (6), at least one section of the part channel (10) being arranged next to the valve stem (15) in the radial direction.

9. The nozzle as claimed in claim 8, in the case of which the part channel (10) and the at least two bypass channels (20a-20e) are distributed uniformly around the valve stem (15) in the circumferential direction.

10. The nozzle as claimed in claim 1, in the case of which the part channel (10) and the vacuum line (9) which opens into the part channel (10) form a Venturi nozzle.

11. The nozzle as claimed in claim 1 which, furthermore, has an automatic switch-off device (30) for actuating the main valve (5), the vacuum line (9) being connected to the automatic switch-off device (30).

12. The nozzle as claimed in claim 1, with the following further features:
the nozzle has a first adjustable maximum volumetric flow and a second maximum volumetric flow which is different than the first maximum volumetric flow, the second maximum volumetric flow being greater than the first maximum volumetric flow,
the nozzle has an adjustable flow limiter which is configured separately from the main valve and is configured to selectively limit the fluid throughflow to the first or second maximum volumetric flow,
the nozzle has an actuating device which is configured to interact with a signal element which is assigned to the tank of a motor vehicle and to selectively set the flow limiter to the first or the second maximum volumetric flow.

13. A method for dispensing a fluid by means of a nozzle as claimed in claim 1, in the case of which method a first proportion of the fluid flow is conducted through the part channel (10) and the remaining proportion of the fluid flow is conducted through the at least two bypass channels (20a-20e), that proportion of the fluid flow which is conducted through the part channel (10) being used to generate a vacuum.

14. The method as claimed in claim 13, in the case of which the at least two bypass channels (20a-20e) in each case have an overflow valve (21a, 21b, 21c, 21d, 21e), the overflow valve (21a, 21b, 21c, 21d, 21e) being used to set that proportion of the fluid flow which flows through the part channel (10).

15. The nozzle as claimed in claim 4, wherein the overflow valve has a closing body (17) which is preloaded upstream into a closed position.
